(19) United States
(12) Patent Application Publication
(10) Pub. No.: US 2003/0208557 A1
(43) Pub. Date: Nov. 6, 2003

(54) Fast document delivery service

(76) Inventors: Robert N. Higbee, Plano, TX (US); John J. Kendrick JR., Dallas, TX (US); Timothy F. Loomis, Plano, TX (US)

Correspondence Address: Timothy F. Loomis, Law Offices of Timothy F. Loomis, 2932 Hagen Drive, Plano, TX, 75025, US

(21) Appl. No.: 09/826,724

(22) Filed: Apr. 5, 2001

(51) Int. Cl. G06F 15/16

(52) U.S. Cl. 709/218

(57) ABSTRACT

A fast and reliable document delivery service in which documents to be delivered are converted to electronic form if they are not already in such form and an image thereof is stored on a database that is securely accessible over the Internet to the intended recipient. The service may include notifying the intended recipient of the availability of documents for delivery, forwarding of the documents to intended recipients and time-limiting availability of documents on the database.

### FIELD OF THE INVENTION

This invention relates to a system and method for providing a fast and reliable document delivery service in which documents to be delivered are converted to electronic form if they are not already in such form and an image thereof is stored on a database that is securely accessible over the Internet to the intended recipient.

### BACKGROUND OF THE INVENTION

In the past, document delivery services tend to have taken too long for many business transactions or have provided less than acceptable quality or features. For those people who must have documents delivered instantaneously, there has been facsimile and email. For those who can wait, there are overnight carriers, such as Federal Express or DHL. For others, there are costly couriers who bicycle documents across town for timely delivery. However, each one of these systems has its drawbacks.

Facsimile is one method of transmitting time sensitive documents in a fairly quick fashion. A document can be inserted into a facsimile machine and a copy of it will be output at the facsimile machine attached to the phone number dialed from the originating machine. While this is usually quite a quick method of transporting documents, it has many problems. First, the quality of the document received by the recipient is low. Faxed documents tend to be blurry. Many times, small print is illegible. If the original is dirty, for instance with smudge marks or stains, the copy received can make the dirt much more damaging to the legibility of the document. Many times this type of quality is unacceptable to people desiring quick delivery of documents.

Another problem with facsimile is that normally fax machines are not set up to handle electronic documents. Electronic documents must be printed out and then input into the machine to fax them to the desired recipient. This is inefficient.

Yet another problem with facsimile is that there is no guarantee that the intended recipient actually receives the facsimile. While someone faxing a document will know if the document is received at a facsimile machine connected to the dialed number, that person does not know that the person who was supposed to receive it actually has it in their hands. A sender may be unaware that an intended recipient is traveling, for instance, and delivery to intended recipient's normal facsimile number will then mean that the intended recipient does not receive the document in a timely fashion. Moreover, if the receiving machine is busy handling other documents, the facsimile may take much longer than expected and may “time-out” and cease attempting to send the document. Additionally, if the facsimile machine on the phone number dialed is actually not the correct fax machine, the sender will not know the document has been misdelivered.

Sending via email solves some of the problems associated with facsimile transmission, but also create some new problems. Email does not require that an electronic document be printed out before being sent. Instead the document is merely attached to an email and sent via a network. However, sending a paper document is not possible. Additionally, some businesses may not accept electronic filings. For instance, a mortgage company may not accept a mortgage application via email, as they may want a signed document.

Utilizing a courier generally takes longer than facsimile or email. This may be acceptable to the recipients at times. But a courier is not the answer for transporting documents long distances. An overnight deliver service can be used in such instances, but the delivery time required may not meet the customer's time frame.

### SUMMARY OF THE INVENTION

An embodiment of the present invention provides a fast and reliable document delivery service in which paper documents are imaged and stored on a database that is securely accessible to the intended recipient over the Internet.

Another embodiment of the present invention provides a fast and reliable document delivery service in which electronic documents are stored on a database that is securely accessible to the intended recipient over the Internet.

As such, it is an object of the present invention to quickly and reliably provide for the delivery of paper documents to an intended recipient over the Internet.

It is a further object of the present invention to quickly and reliably provide for the delivery of electronic documents to an intended recipient over the Internet.

It is yet a further object of the present invention to notify an intended recipient of a document to be delivered over the Internet that a document is available for retrieval.

### BRIEF DESCRIPTION OF THE DRAWINGS

FIG. 1 is a block diagram of a system for providing delivery of documents to an intended recipient according to an embodiment of the present invention.

FIG. 2 is a flow chart showing the process of the first portion of a document delivery service according to an embodiment of the present invention.

FIG. 3 is a flow chart showing the process of the second portion of a document delivery service according to an embodiment of the present invention.

### DESCRIPTION OF THE PREFERRED EMBODIMENTS

The present invention will be better understood by reference to the accompanying drawings.

A system such as that disclosed in patent application Ser. No. 09/783,161 filed on Feb. 14, 2001 and assigned to ControlDocs Operating Corp., may be modified to provide a service as disclosed herein. That application is herein incorporated by reference.

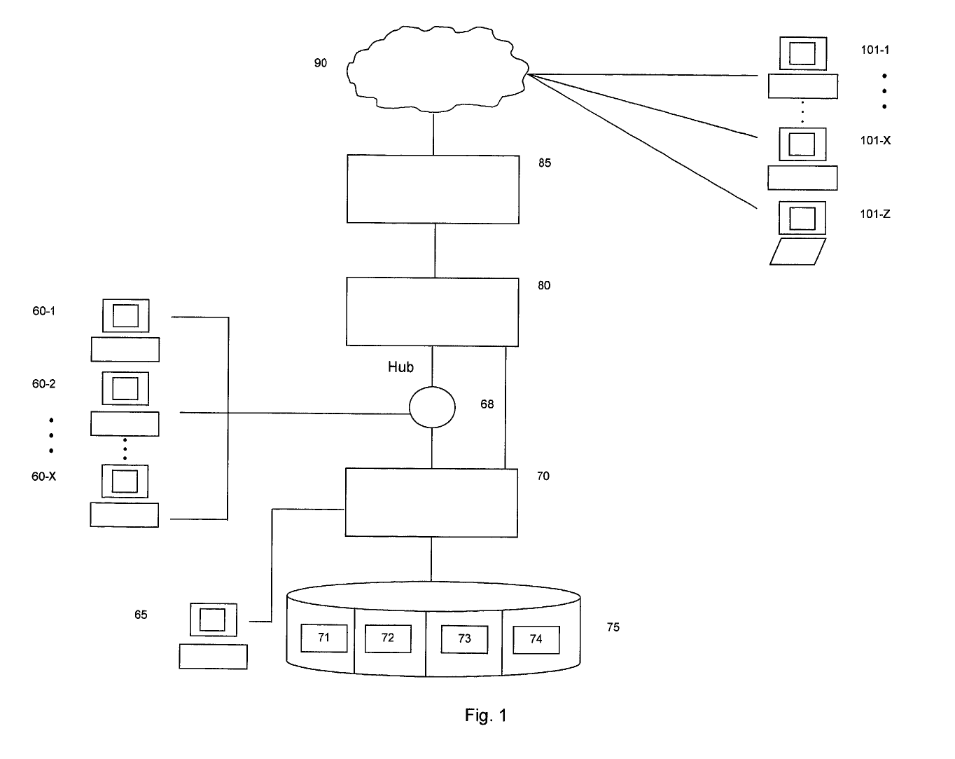

An embodiment of the present invention is depicted in FIG. 1. Referring to that figure, a database 75 for storing images of paper documents and electronic documents, document indexes and/or summaries (for simplicity purposes, the term index as used hereinafter shall mean index and/or summary), OCR records of documents and notes is provided. Preferably, the database is a RAID array. Alternatively, multiple separate databases or other electronic storage media could be used.

Document management service 70 is connected to database 75. Document management service 70 provides the interface between the database and the outside world. It provides the search, retrieval and note taking capabilities to the intended recipient of the documents to be delivered. Document management service 70 includes capabilities such as those provided by software commercially available from Precise Systems Corporation, including document collection and database creation. It may also contain a conversion tool for converting incoming electronic documents to a standard format for storage and delivery.

Managers can be connected to the document management service 70, such as manager 65. Manager 65 can provide management functions, such as password assignment for intended recipients, account management, other security functions and database administration.

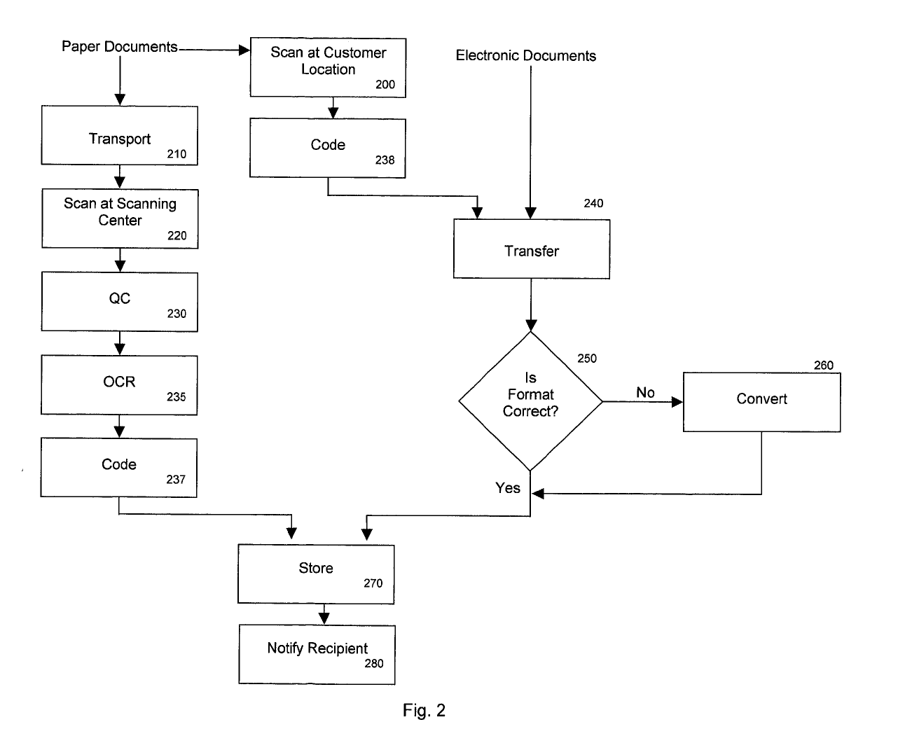

Document management service 70 may also be connected to a hub 68 for providing access to the service for document workers 60-1 through 60-x. This permits document workers 60-1 through 60-x to scan, code and store paper documents in database 75. This process will be discussed more thoroughly with regards to FIG. 2.

Hub 68 and document management service 70 can be connected to a web server and firewall 80 for providing secure access to the Internet 90. As used herein, the Internet shall encompass not only the present day Internet, but any future network that provides the broad connectivity that the Internet currently does. A router 85 may be included for connection to Internet 90. By connecting hub 68 to the Internet 90, access is provided for document workers 60-1 through 60-x to the Internet 90 so that they may communicate with recipients when a document ready to be delivered. Alternatively, if this arrangement causes security concerns, hub 68 could not be attached to webserver and firewall 80. Under this alternative arrangement, document workers 60-1 through 60-x would be forced to go through document control service 70 to access the Internet. The notification of a document ready to be delivered could alternatively be automated by document control service 70.

Intended recipients 101-1 through 101-x have access to the documents being sent to them that are stored in database 75, such as document 71, through the Internet 90. Intended recipients 101-1 through 101-x may also access a document through a search of indexes, such as index 72, or a search of OCR files representing documents, such as OCR file 73. Document management service 70 would provide the search functions. Preferably, recipients 101-1 through 101-x would be permitted to access the images being sent to them for a specified period of time prior to the documents being deleted from database 75. Alternatively, the documents could be permanently stored.

Preferably, document control system 70 would provide the intended recipient and/or the sender with the ability to provide notes relating to the document, such as notes 74. Note making capability is currently available in litigation management software from Precise Systems, Inc. By providing note capability, the sender and recipient would be able to communicate regarding the document without altering the document. Preferably, notes 74 would be associated with image 71 so that a recipient could selectively change between viewing image 71 and notes 74. Also, preferably, notes 74 would be associated with image 71 in such a way that they would appear to recipient to be the image 71 with certain text highlighted and/or with sticky pad notes attached. The highlighting could be, for instance, a contrasting color overlaid on the document, different colored text, boxed or circled text, bolded text, underlined text, italicized text, or the like.

Intended recipient 101-z, a recipient traveling and operating a laptop from a location remote from his office and from the document storage area, is also connected through the Internet 90 to the document management service 70 and database 75. Preferably, recipient 101-z interoperates with the central document storage area just as recipients 101-1 through 101-x, so that when a recipient that normally receives the documents through a fixed location has to travel and is receiving documents, the procedure he has to undertake is the same.

In FIG. 2, a flow chart showing the process of delivery of documents through a system according to an embodiment of the present invention is shown. Two process flows are depicted—one for paper documents and the other for electronic documents. A paper document needs to be scanned prior to it being stored in the document storage system for delivery. If the sender of the document has a scanner available to him, he could scan the document locally as shown in step 200 and send the image of the document electronically by, for example, attaching it to an email to the document storage system as shown in step 240. An optical character recognition process could be applied to the image to produce a searchable representation of the image as shown in step 205. This process could be performed either prior to or after transfer to the document storage system.

If the sender prefers, he could transport the documents to a scanning center as shown in step 210. In step 220, an incoming paper document is scanned at the scanning center into the system to create an image of the document. Preferably, scanning stations will be set up in cities near major customer locations so that each customer can get the documents to be delivered to a scanning station in a short period of time. In step 230, a quality control procedure can be undertaken to ensure that the document has been properly scanned. The image is then put through an optical character recognition process to create an OCR file that is a searchable representation of the image in step 235. Once this is complete, the document is stored in the document storage facility in step 270.

If the document is originally in electronic form, the sender simply transfers the electronic document to the document storage facility. If the document storage facility is remotely located and/or independent from the sender, the sender may simply attach the electronic document to an email and send it to the document storage facility via the Internet to a designated email address.

Once an electronic document is received by the document storage facility, it is determined in step 250 if the document is in the appropriate format for storage. If it is not, it is converted to the appropriate format in step 260. In step 265, a quality control process can be undertaken.

Once the document exists in the appropriate format, it is stored into database 75 in step 270. This places the document in condition for delivery.

In step 280, the intended recipient may be notified that a document is available for receipt. As mentioned above, this notification could be automatically generated and sent via email by document control system 70. Alternatively, it could be sent by one of document workers 60-1 through 60-x. Preferably, the email would contain some information relating to the document, such as length and the identity of the sender. The notification could be provided to multiple email addresses, such as a business address, a personal address and the intended recipient's assistant. Alternative methods of notification could include a phone call, voice mail, page, etc. Additionally, separate levels of notification could be used. For example, an email could be sent. If the intended recipient has not accessed the document being sent to him or her within a predetermined time period, another notification could be sent. This second notification could be by a different means, a phone call for example, or be another email. Additional levels of notification could be used.

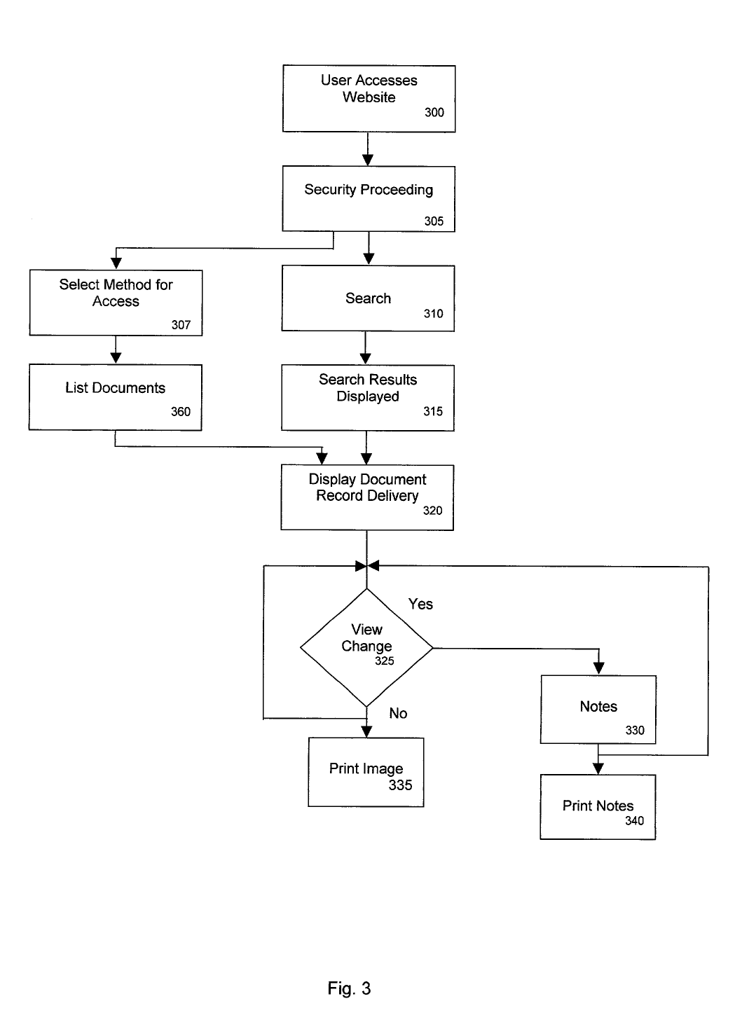

FIG. 3 shows the process undertaken to receive a document delivery according to an embodiment of the present invention. In step 300, a recipient accesses the website of the centralized document storage facility through the Internet. By having the website accessible via the Internet, recipients working on fixed sites, such as recipients 101-1 through 101-x can have access to the documents stored therein, as well as recipients who are traveling, such as recipient 101-z.

After the recipient accesses the website, in step 305 security procedures are engaged in order to permit the recipient to access the documents that recipient is being sent from database 75. Preferably, the security procedures include requiring the recipient to log on to the secure portion of the website, prior to gaining access to the document management system 70. Preferably, the recipient will be required to enter a unique recipient ID and password and further transmission of information between the recipient and the central document storage system will be encrypted. Thus, any information intercepted by a third party will be unintelligible. This is important because many documents being transmitted may cause strong security concerns among the customers of such a system. The recipient ID and password could be stored in the recipient's computer, so that the recipient does not need to reenter it every time he logs in or he could be required to enter them each time, depending on the security concerns involved. The recipient ID and password should sufficiently identify the recipient so that access can be granted only to documents within database 75 that are being sent to the recipient. ID, password and encryption software are currently widely available and such software could be integrated into web server and firewall 80 and/or document management service 70 to address the security concerns.

Once access to the secure portion of the website is accomplished, a recipient can choose a method of accessing sent documents as shown in step 307. One method of accessing sent documents is through a list of the documents sent to the recipient that are available as shown in step 360. Preferably this is a list of hyperlinks. If only one document is available, it could be listed, or alternatively, the document could be presented to the recipient without the necessity for the recipient to select the document. Once the recipient selects one of the documents to be delivered by clicking on an item in the list, the document stored in database 75 is displayed in step 320.

Preferably, once the document is displayed to the recipient, the document management system records that the document has been delivered. The record of delivery should include the date and time of the delivery and the identification of the person to whom the document is delivered. This can be helpful if a dispute arises as to whether a document was delivered to the intended recipient.

Another method is through a search. If numerous documents are available for delivery, a recipient may want to search for specific terms within the documents. In this method a search page is displayed in step 310, enabling the user to search the OCR files corresponding to the documents available for delivery for specific information. For example, user 101-1 could enter a search term of “Robert Smith” to search for documents that mention Mr. Smith. Many search engines are currently commercially available that can be integrated into document management service 70 to handle the search functions.

In step 315, the results of the search are displayed, preferably as a list of hyperlinks of the images associated with the OCR files. In the example listed above, for instance, five documents written by Mr. Smith and 2 documents that mention Mr. Smith could be listed. If the recipient were to click on one of the an item in the list, he should then be shown the image of the corresponding document stored on database 75, as noted in step 320.

If only one document is available, it could be listed, or alternatively, the image of the document could be presented to the recipient without the necessity for the recipient to select the document. In step 315, the recipient selects the document he wishes to be delivered by clicking on one of the items in the list. He is then shown the image of the document stored on database 75, as noted in step 320.

When shown the image of the document, the recipient should be able to magnify the document and rotate the document to improve legibility. Software permitting such manipulation of documents is currently commercially available. Also, the recipient should be able to change the view as shown in step 325 to display any notes relating to the document being viewed. Preferably, the notes view as mentioned in step 330 would look like the image but with notes superimposed upon the image, so that highlighting could be added. The notes, for instance, could appear similar to sticky notes. The recipient should be able to add to the notes and/or amend the notes as well.

The recipient is also permitted to print the document in step 335 or the notes in step 340. Preferably, this would print the entire selected document (not just the page being viewed) locally at the recipient location. Thus, if a recipient were away from his office he could easily print copies of the document being delivered. Alternatively, the document could be downloaded by the recipient. If desired, the logic flow can be arranged differently than is shown in FIG. 3. For example, a recipient could be able to print the document while viewing the notes or print the notes while viewing the document.

Although the preferred embodiments of the present invention have been described and illustrated in detail, it will be evident to those skilled in the art that various modifications and changes may be made thereto without departing from the spirit and scope of the invention as set forth in the appended claims and equivalents thereof.

What is claimed is:

1. A method of delivering a document to an intended recipient comprising the steps of:
storing said document on a storage medium;
providing a website accessible through an Internet;
when said recipient accesses said website, verifying said recipient's identity;
displaying to said recipient which documents stored in said storage medium are available for said recipient to receive;
providing said recipient with a selected one of said documents available for said recipient to receive.

2. A method of delivering a document as in claim 1, wherein said providing step comprises displaying said document to said recipient.

3. A method of delivering a document as in claim 1, wherein said providing step comprises permitting said recipient to print said selected document at recipient's location.

4. A method of delivering a document as in claim 1, wherein said providing step comprises downloading said selected document to said recipient.

5. A method of delivering a document as in claim 1, wherein said displaying step comprises displaying a list of hyperlinks, said hyperlinks representing documents available on said storage medium to said recipient.

6. A method of delivering a document as in claim 2, further comprising the step of permitting said recipient to rotate said document being displayed.

7. A method of delivering a document as in claim 2, further comprising the step of permitting said recipient to magnify said document being displayed.

8. A method of delivering a document as in claim 2, further comprising the steps of:
associating a notes file with said document;
permitting said recipient to switch views between said selected document and said notes file;
permitting said recipient to add information to said notes file;
making said notes file available to a sender of said document.

9. A method of delivering a document as in claim 7, wherein said sender may create said notes file when sending said document.

10. A method of delivering a document as in claim 1, wherein said storing said document step comprises scanning a paper document into a computer system, so as to create an image of said paper document.

11. A method of delivering a document as in claim 9, wherein said storing said document step further comprises scanning said paper document at a site remote from said storage medium and electronically transmitting said image to said storage medium.

12. A method of delivering a document as in claim 10, wherein said site remote from said storage medium is said sender's premises.

13. A method of delivering a document as in claim 9, wherein said storing said document step further comprises scanning said paper document into said storage medium at a site collocated with said storage medium.

14. A method of delivering a document as in claim 1, wherein said storing said document step comprises electronically transferring said document to said storage medium.

15. A method of delivering a document as in claim 13, further comprising the step of converting a format of said document to a format selected for electronic documents to be stored on said storage medium.

16. A method of delivering a document as in claim 1, further comprising the step of notifying said recipient that said document is available to be delivered.

17. A method of delivering a document as in claim 15, wherein said notification comprises an email.

18. A method of delivering a document as in claim 15, wherein said notification comprises a page.

19. A method of delivering a document as in claim 15, wherein said notification comprises a voice mail.

20. A method of delivering a document as in claim 15, wherein said notification comprises a phone call.

21. A method of delivering a document as in claim 15, further comprising the step of notifying said recipient a second time that said document is available to be delivered if said recipient has not accessed said document within a predetermined time period.

22. A method of delivering a document as in claim 20, wherein said second notification is by a different method than said notification.

23. A method of delivering a document as in claim 1, wherein said storage medium comprises a database.

24. A method of delivering a document as in claim 22, wherein said storage medium comprises a RAID array.

25. A method of delivering a document as in claim 1, further comprising a step of storing a record of delivery of said document.
